(19) United States
(12) Patent Application Publication
(10) Pub. No.: US 2025/0072311 A1
(43) Pub. Date: Mar. 6, 2025

(54) SYSTEMS AND METHODS FOR AN AGRICULTURAL IMPLEMENT

(71) Applicant: CNH Industrial America LLC, New Holland, PA (US)

(72) Inventor: Brittany Schroeder, Bunker Hill, IN (US)

(21) Appl. No.: 18/457,731

(22) Filed: Aug. 29, 2023

(51) Int. Cl. A01B 79/00; A01B 29/04; A01B 63/24

(52) U.S. Cl. CPC A01B 79/005; A01B 29/048; A01B 63/24

(57) ABSTRACT

An agricultural system can include an implement including a frame assembly. A basket assembly can be operably coupled with the frame assembly. A basket assembly actuator can be operably coupled with the basket assembly and the frame assembly. The basket assembly actuator can be configured to alter a position of the basket assembly relative to the frame assembly. A computing system can be communicatively coupled to the basket assembly actuator. The computing system can include a processor and associated memory, the memory storing instructions that, when implemented by the processor, configure the computing system to receive a defined soil finish, receive data indicative of a soil profile, determine a soil compaction limit based on the soil profile, and determine a defined basket assembly actuator position based at least partially on the soil compaction limit and the defined soil finish.

### FIELD OF THE INVENTION

The present subject matter relates generally to tillage implements that may be operated within an agricultural field.

### BACKGROUND OF THE INVENTION

In some cases, to increase agricultural performance from a field, a farmer may cultivate the soil, typically through a tillage operation. For instance, tillage operations may be performed by pulling a tillage implement behind an agricultural work vehicle, such as a tractor. Tillage implements can include one or more ground-engaging tools configured to engage the soil as the implement is moved across the field. For example, in certain configurations, the implement may include one or more harrow discs, leveling discs, rolling baskets, shanks, tines, and/or the like. Such ground-engaging tool(s) loosen and/or otherwise agitate the soil to prepare the field for subsequent planting operations.

During tillage operations, various levelers may be used to backfill the soil created by a ground-engaging tool thereby forming ridges and/or valleys within the field. The various ridges of soil settle over time due to the soil being loosened. In various cases, different soil types settle differently. Accordingly, an improved system and method for developing ridges or mounds of soil would be welcomed in the technology.

### BRIEF DESCRIPTION OF THE INVENTION

Aspects and advantages of the technology will be set forth in part in the following description, or may be obvious from the description, or may be learned through practice of the technology.

In some aspects, the present subject matter is directed to an agricultural system that includes an implement including a frame assembly. A basket assembly is operably coupled with the frame assembly. A basket assembly actuator is operably coupled with the basket assembly and the frame assembly. The basket assembly actuator is configured to alter a position of the basket assembly relative to the frame assembly. A computing system is communicatively coupled to the basket assembly actuator. The computing system including a processor and associated memory, the memory stores instructions that, when implemented by the processor, configure the computing system to receive a defined soil finish, receive data indicative of a soil profile, determine a soil compaction limit based on the soil profile, and determine a defined basket assembly actuator position based at least partially on the soil compaction limit and the defined soil finish.

In some aspects, the present subject matter is directed to a method for operating an agricultural system. The method includes receiving, with a computing system, data indicative of a soil type. The method also includes receiving, with the computing system, data indicative of a soil profile. The method further includes determining, with the computing system, a soil compaction limit based at least partially on the soil profile and the soil type.

In some aspects, the present subject matter is directed to an agricultural system that includes an implement including a frame assembly. A basket assembly is operably coupled with the frame assembly. A basket assembly actuator is operably coupled with the basket assembly and the frame assembly. The basket assembly actuator is configured to alter a position of the basket assembly relative to the frame assembly. A computing system is communicatively coupled to the basket assembly actuator, the computing system including a processor and associated memory. The memory stores instructions that, when implemented by the processor, configure the computing system to receive data indicative of a soil compaction limit and determine a defined basket assembly actuator position based at least partially on the soil compaction limit.

These and other features, aspects, and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a front perspective view of an agricultural machine in accordance with aspects of the present subject matter;

FIG. 2 illustrates a front perspective view of an agricultural implement in accordance with aspects of the present subject matter;

FIG. 3 illustrates a rear perspective view of the agricultural implement in accordance with aspects of the present subject matter;

FIG. 4 illustrates a block diagram of components of a system for an agricultural machine in accordance with aspects of the present subject matter;

FIG. 5 illustrates various components a block diagram of some of the components of the system for an agricultural machine in accordance with aspects of the present subject matter; and

FIG. 6 illustrates a flow diagram of a method for operating an agricultural system in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the disclosure, one or more examples of which are illustrated in the drawings. Each example is provided by way of explanation of the discourse, not limitation of the disclosure. In fact, it will be apparent to those skilled in the art that various modifications and variations can be made in the present disclosure without departing from the scope or spirit of the disclosure. For instance, features illustrated or described as part can be used with another embodiment to yield a still further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to an agricultural product within a fluid circuit. For example, “upstream” refers to the direction from which an agricultural product flows, and “downstream” refers to the direction to which the agricultural product moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C. the composition or assembly can contain A alone; B alone; C alone; A and B in combination; A and C in combination; B and C in combination; or A, B, and C in combination.

In general, the present subject matter is directed to agricultural systems and methods for operating the agricultural systems that may incorporate a tillage implement. In some cases, tillage implements are used to remove soil compaction, either surface or deep, and improve the overall soil tilth for improved crop production and growth. However, if the implement is not set up correctly as one potential field problem is alleviated, another problem can be created through improper surface finish. Surface finish is considered the soil levelness, residue coverage, and soil roughness that may be a measure of soil clod size distribution. Surface roughness or clod sizing can be controlled by an operating disk depth and/or a basket pressure for various implements. The operating disk and cultivator shanks/sweeps depth and spacing can determine the initial size of the clods and the basket pressure can determine the final clod size. If the basket pressure is low relative to a defined threshold, the probability of large clods or the surface finish being cloddy is more likely. If the basket pressure is high relative to the defined threshold, the probability of small clods or a smooth surface finish is more likely, assuming normal soil with low bulk density.

In addition, soil compaction can affect how the tillage tools perform within the field. Soil compaction can occur when particles of the soil are pressed together to reduce the air space between them. As such, relatively highly compacted soils contain few spaces resulting in soil with higher unit weight and a relatively lower compacted soil can contain more spaces resulting in soil with lower unit weight. However, the soil profile data may also define any other characteristic of the soil within the field without departing from the scope of the present disclosure. In some cases, if soil compaction has a bulk density greater than 1.5 g/cm³ (or any other defined threshold), the basket pressure may be adjusted to or near a defined operating pressure to break up the large boulders that the disk or sweeps cut up from the soil. Therefore, a defined basket pressure may be adjusted as the soil compaction level is changed to achieve a defined soil finish.

In some cases, the agricultural system can include an implement including a frame assembly. A basket assembly can be operably coupled with the frame assembly. A basket assembly actuator can be operably coupled with the basket assembly and the frame assembly. The basket assembly actuator can be configured to alter a position of the basket assembly relative to the frame assembly.

A computing system can be communicatively coupled to the basket assembly actuator. The computing system can include a processor and associated memory, the memory storing instructions that, when implemented by the processor, configure the computing system to receive a defined soil finish, receive data indicative of a soil profile, determine a soil compaction limit based on the soil profile, and determine a defined basket assembly actuator position based at least partially on the soil compaction limit and the defined soil finish. As such, a defined soil finish may be achieved and maintained as the soil profile, including the soil compaction level, changes through a field.

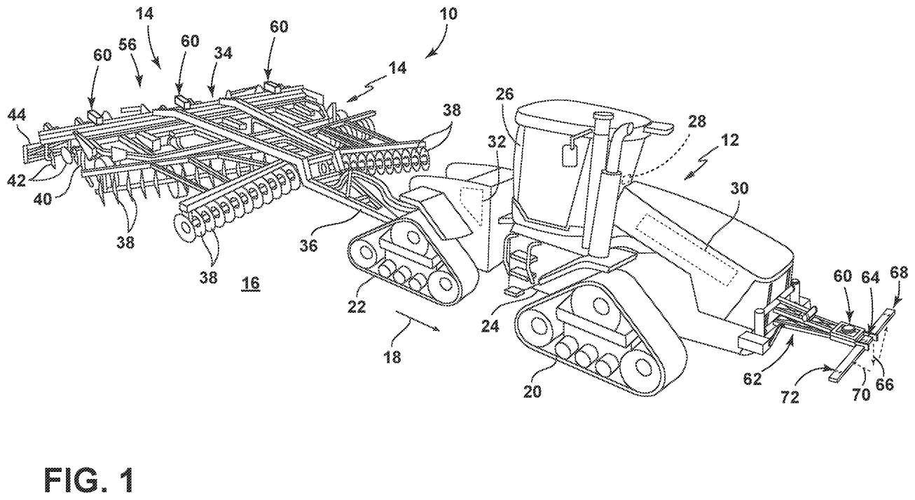

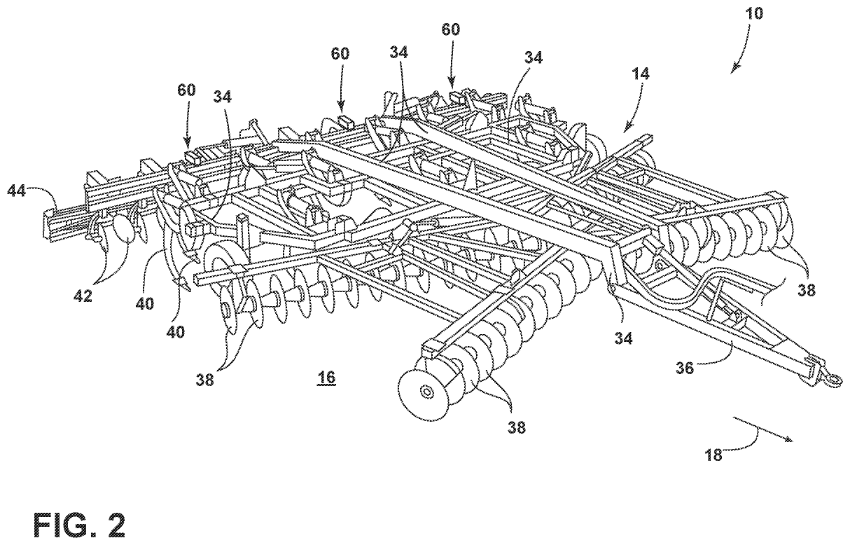

Referring now to drawings, FIGS. 1-3 respectively illustrate a front perspective view, a rear perspective view, and a partial rear perspective view of an agricultural machine 10 in accordance with various aspects of the present subject matter. As shown, the agricultural machine 10 can include a work vehicle 12 and an associated agricultural implement 14. In general, the work vehicle 12 is configured to tow the implement 14 across a field 16 in a direction of travel (e.g., as indicated by arrow 18 in FIG. 1). In the illustrated examples, the work vehicle 12 is configured as an agricultural tractor and the implement 14 is configured as an associated tillage implement. However, in other embodiments, the work vehicle 12 may be configured as any other suitable type of vehicle, such as an agricultural harvester, a self-propelled sprayer, and/or the like. Similarly, the implement 14 may be configured as any other suitable type of implement, such as a planter. Furthermore, the agricultural machine 10 may correspond to any suitable powered and/or unpowered agricultural machine 10 (including suitable vehicles and/or equipment, such as only a work vehicle or only an implement). Additionally, the agricultural machine 10 may include two or more associated vehicles, implements, and/or the like (e.g., a tractor, a planter, and an associated air cart).

As shown in FIG. 1, the work vehicle 12 includes a pair of front track assemblies 20, a pair of rear track assemblies 22, and a frame or chassis 24 coupled to and supported by the track assemblies 20, 22. An operator's cab 26 may be supported by a portion of the chassis 24 and may house various input devices 28 for permitting an operator to control the operation of one or more components of the work vehicle 12 and/or one or more components of the implement 14. Additionally, the work vehicle 12 may include a power source 30 and a transmission 32 mounted on the chassis 24. The transmission 32 may be operably coupled to the power source 30 and may provide variably adjusted gear ratios for transferring power to the track assemblies 20, 22 via a drive axle assembly (or via axles if multiple drive axles are employed).

Additionally, as shown in FIGS. 1-3, the implement 14 may generally include a frame assembly 34 configured to be towed by the work vehicle 12 via a pull hitch or tow bar 36 in the direction of travel 18 of the vehicle 12. The frame assembly 34 may be configured to support a plurality of ground-engaging tools, such as a plurality of shanks, disk blades, levelers (e.g., leveling blades), basket assemblies 44, tines, spikes, and/or the like. For example, the frame assembly 34 may be configured to support various gangs of disc blades 38, a plurality of ground engaging shanks 40, a plurality of levelers 42 (e.g., leveling blades), and a plurality of crumbler wheels or basket assemblies 44. However, in alternative embodiments, the frame assembly 34 may be configured to support any other suitable ground-engaging tools and/or a combination of ground-engaging tools. In several embodiments, the various ground-engaging tools may be configured to perform a tillage operation or any other suitable ground-engaging operation across the field 16 along which the implement 14 is being towed. It should be understood that, in addition to being towed by the work vehicle 12, the implement 14 may also be a semi-mounted implement connected to the work vehicle 12 via a two-point hitch or the implement 14 may be a fully mounted implement (e.g., mounted the work vehicle's three-point hitch).

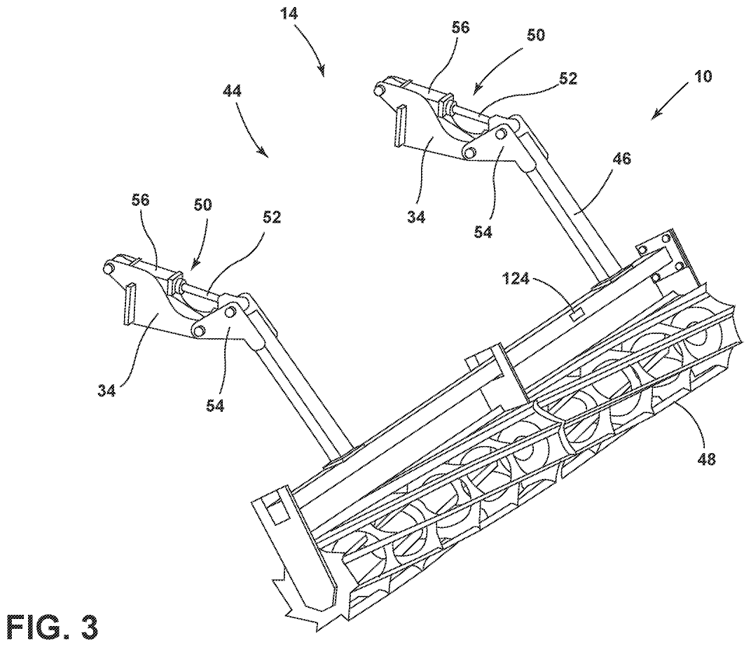

As illustrated in FIG. 3, the basket assembly 44 may include a basket assembly frame 46 that rotatably supports one or more rolling (or crumbler) baskets 48. The baskets 48 may, in turn, be configured to roll along the soil surface, thereby breaking up dirt clods or otherwise reducing the soil roughness of the field 16 across which the implement 14 is being moved. Furthermore, the basket assemblies 44 may be pivotable or otherwise moveable relative to the frame assembly 34 to permit one or more basket assembly actuators 50 to adjust the position of the basket assembly 44 relative to the frame assembly 34. For example, in some examples, a first end portion of each actuator 50 (e.g., a rod 52 of the actuator 50) may be coupled to a support bracket 54, which is, in turn, coupled to the basket assembly frame 46, while a second end portion of each actuator 50 (e.g., the cylinder 56 of the actuator 50) may be coupled to the frame assembly 34. The rod 52 of each actuator 50 may be configured to extend and/or retract relative to the corresponding cylinder 56 to adjust the down pressure being applied to the baskets 48. The basket assembly actuators 50 may also allow the basket assemblies 44 to be raised off the ground, such as when the implement 14 is making a headland turn and/or when the implement 14 is being operated within its transport mode. In the illustrated embodiment, each actuator 50 can correspond to a fluid-driven actuator, such as a hydraulic or pneumatic cylinder. However, it should be appreciated that each actuator 50 may correspond to any other suitable type of actuator, such as an electric linear actuator.

It will be appreciated that the configuration of the agricultural machine 10 described above and shown in FIGS. 1-3 is provided only to place the present subject matter in an example field of use. Thus, it will be appreciated that the present subject matter may be readily adaptable to any manner of machine configuration, including any suitable work vehicle configuration and/or implement configuration. For example, in an alternative embodiment of the work vehicle 12, a separate frame or chassis may be provided to which the power source 30, transmission, and drive axle assembly are coupled, a configuration common in smaller tractors. Still other configurations may use an articulated chassis to steer the work vehicle 12 or rely on tires/wheels in lieu of the track assemblies 20, 22. Similarly, as indicated above, the frame assembly 34 of the implement 14 may be configured to support any other suitable combination of type of ground-engaging tools.

Furthermore, in accordance with aspects of the present subject matter, the agricultural machine 10 may include one or more field sensor 60 coupled thereto and/or supported thereon. Each field sensor 60 may, for example, be configured to capture data indicative of one or more conditions of the field 16 along which the machine 10 is being traversed. For example, in several embodiments, the field sensor 60 may be used to collect data associated with one or more features of the field 16, such as one or more subsurface soil layer characteristics of the field 16, such as the presence and/or location of a subsurface soil compaction layer. Additionally or alternatively, the field sensors 60 may collect data associated with at least one of a soil percent moisture, a field residue levels/amounts, an opener movement (e.g., ride quality, a minimum ground contact percentage), a field traffic, a weight of a work vehicle 12 or the implement 14, a soil type, a soil composition, a topsoil depth, a subsoil depth, a field elevation, a tire traction, sensor data from one or more load sensors, a seeder speed, and/or any other suitable condition that affects the performance of the implement 14.

In some cases, the field sensor 60 may be provided in operative association with the agricultural machine 10 such that the field sensor 60 has a field of view directed towards a region of the field 16 adjacent to the work vehicle 12 and/or the implement 14, such as a region of the field 16 disposed in front of, behind, and/or along one or both of the sides of the work vehicle 12 and/or the implement 14. For example, as shown in FIG. 1, in some embodiments, a suitable mounting structure 62 (e.g., mounting arms, brackets, trays, etc.) may be used to support a field sensor 60 forwardly of the implement 14 (e.g., in a cantilevered arrangement) to allow the field sensor 60 to obtain the desired field of view, including the desired orientation of the device's field of view relative to the field 16. Such a forward-located field sensor 60 may allow pre-tillage images of the field 16 to be captured for monitoring or determining surface conditions of the field 16 (e.g., soil clods) prior to the performance of a tillage operation.

Additionally or alternatively, the field sensor 60 may be installed at any other suitable location(s) on the work vehicle 12 and/or the implement 14. In addition, the agricultural machine 10 may only include a single field sensor 60 mounted on either the work vehicle 12 or the implement 14 or may include more than two field sensors 60 mounted on the work vehicle 12 and/or the implement 14. Moreover, it will be appreciated that each field sensor 60 may be configured to be mounted or otherwise supported relative to a portion of the agricultural machine 10 using any suitable mounting/support structure. For instance, each field sensor 60 may be directly or indirectly mounted to a portion of the work vehicle 12 and/or the implement 14.

Referring further to FIGS. 1-3, in general, the field sensor 60 may correspond to any suitable device(s) or other assembly configured to capture data of the field 16. For instance, in several embodiments, the field sensor 60 may correspond to a radio detection and ranging (RADAR) sensor system, and/or any other practicable device. The RADAR system can include one or more transmitters 64 operative to emit an electromagnetic wave 66, with the one or more transmitters 64 positioned within a housing 68. The electromagnetic wave 66 may be directed towards a region of the field 16, and/or in any other direction. A portion 70 of the electromagnetic wave 66 is reflected off of the region of the field 16 (and/or objects within the region of the field 16) toward a receiver 72, which may also be within, or separated from, the housing 68. The receiver 72 is configured to receive and detect the portion 70 of the electromagnetic wave 66 reflected off of the region of the field 16 (and/or objects within the region of the field 16).

The RADAR system can further include a transmitting antenna, and a receiving antenna (the same antenna can be used for transmitting and receiving) configured to determine the directionality of any detected objects. Since the electromagnetic wave 66 travels at a defined speed, a distance between the RADAR system and the region of the field 16 may be determined based on the determined time of flight. By determining the time of flight for each electromagnetic wave 66 emitted at a respective emission location, the RADAR system can determine soil profile data to a defined distance below the surface. In some examples, the soil profile can include a measure of soil compaction, which occurs when particles of the soil are pressed together to reduce the air space between them. As such, relatively highly compacted soils contain few spaces resulting in soil with higher unit weight and a relatively lower compacted soil can contain more spaces resulting in soil with lower unit weight. However, the soil profile data may also define any other characteristic of the soil within the field 16 without departing from the scope of the present disclosure.

It will be appreciated that, in addition to a RADAR system or as an alternative thereto, the agricultural machine 10 may include any other suitable type of field sensor 60. For instance, suitable field sensor 60 may also include an ultrasonic sensor, a Light Detection and Ranging (LIDAR) sensor, a sound navigation and ranging (SONAR) sensor, a vision-based sensor, and/or any other practicable sensor.

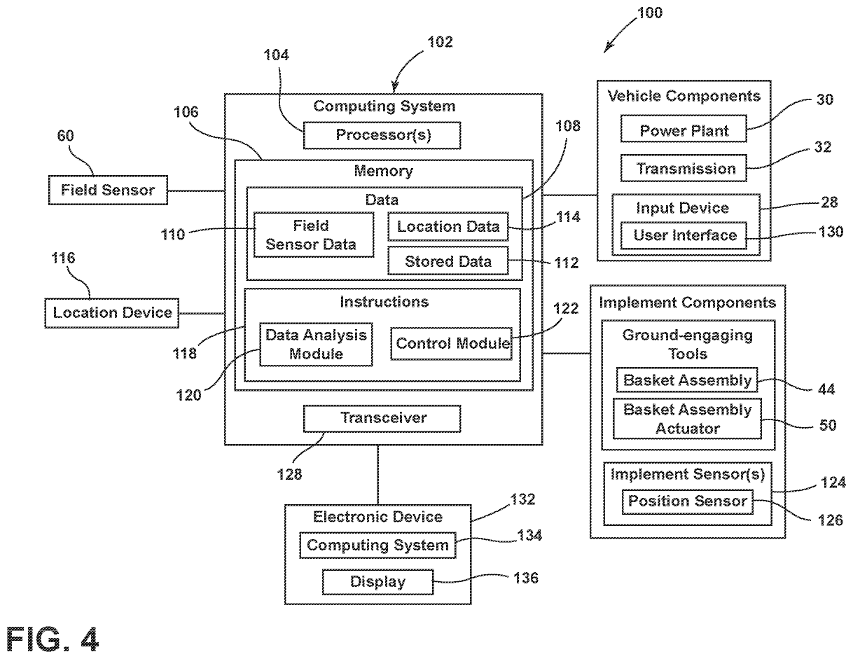

Referring now to FIG. 4, a schematic view of a system 100 for an agricultural machine 10 is illustrated in accordance with aspects of the present subject matter. In several embodiments, the disclosed system 100 is configured for detecting soil clods within an agricultural field 16. The system 100 will generally be described herein with reference to the agricultural machine 10 described above with reference to FIGS. 1-3. However, the disclosed system 100 may generally be utilized with agricultural machines having any other suitable machine configuration.

As shown in FIG. 4, the system 100 may include one or more field sensors 60 configured to capture data indicative of various conditions of a region of the field 16 disposed adjacent to the work vehicle 12 and or the implement 14. Additionally, the system 100 may include or be associated with one or more components of the agricultural machine 10 described above with reference to FIGS. 1-3, such as one or more components of the work vehicle 12 and/or the implement 14.

The system 100 may further include a computing system 102 communicatively coupled to the field sensor 60. In several embodiments, the computing system 102 may be configured to receive and process the data captured by the field sensor 60. For instance, the computing system 102 may be configured to receive soil data indicative of a soil profile and execute one or more suitable data processing algorithms for detecting the soil compaction limit. Additionally or alternatively, a soil profile may be provided to the computing system 102 through any other manner, such as through a soil map and/or through inputted soil data. In turn, the computing system 102 may determine a defined position of the one or more basket assemblies 44 based in part on the determined soil type. In some cases, as the soil profile within the field 16 varies, the position of each basket assembly 44 may be adjusted through the basket assembly actuator 46. The computing system 102 may further be configured to receive soil type data of a field 16 and execute one or more suitable data processing algorithms for determining a defined basket assembly actuator 46 position based at least partially on the soil compaction limit and the defined soil type.

For purposes of the present disclosure, soil may be generally made up of particles called sand, silt, and clay. These particles are classified by size according to the USDA textural classification (from largest to smallest): sand particles are 0.05-2 mm, silt particles are 0.002-0.05 mm, and clay particles are less than 0.002 mm. When arranged in soil, these particles have voids or pores between them, and the pores can be filled with either air or water. In well-balanced soil, the primary particles (sand, silt, and clay) can occupy about 45% of the soil volume, while water and air together can constitute about 50% of the soil volume. The remaining 5% can be the organic component of the soil. The amount of the organic component can be variable in the soil, depending on factors such as soil management, cropping systems, climate, and/or any other factor. Moreover, the soil compaction limit may be variable based on the makeup of the soil and defined by the computing system 102, a user of the agricultural system, and/or through any other manner.

In general, the computing system 102 may include any suitable processor-based device, such as a computing device or any suitable combination of computing devices. Thus, in several embodiments, the computing system 102 may include one or more processors 104 and associated memory 106 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory 106 of the computing system 102 may generally comprise memory element(s) including, but not limited to, a computer-readable medium (e.g., random access memory (RAM)), a computer-readable non-volatile medium (e.g., a flash memory), a floppy disk, a compact disc-read only memory (CD-ROM), a magneto-optical disk (MOD), a digital versatile disc (DVD) and/or other suitable memory elements. Such memory 106 may generally be configured to store suitable computer-readable instructions that, when implemented by the processors 104, configure the computing system 102 to perform various computer-implemented functions, such as one or more aspects of the data processing algorithm(s) and/or related method(s) described below. In addition, the computing system 102 may also include various other suitable components, such as a communications circuit or module, one or more input/output channels, a data/control bus, and/or the like.

It will be appreciated that, in several embodiments, the computing system 102 may correspond to an existing controller of the agricultural machine 10, or the computing system 102 may correspond to one or more separate processing devices. For instance, in some embodiments, the computing system 102 may form all or part of a separate plug-in module or computing device(s) that is installed relative to the work vehicle 12 or implement 14 to allow for the disclosed system 100 and method to be implemented without requiring additional software to be uploaded onto existing control devices of the work vehicle 12 or implement 14.

In several embodiments, the memory 106 of the computing system 102 may include one or more databases 108 for storing information received and/or generated by the computing system 102. For instance, as shown in FIG. 4, the memory 106 may include a field sensor database 110 storing data associated with the field data captured by the field sensor 60, including the captured data and/or data deriving from the captured data (e.g., disparity maps, depth images generated based on the captured data by the field sensor 60, etc.). Additionally, the memory 106 may include a stored data database 112 storing data acquired from various sources. For instance, as indicated above, the stored data can include a soil type map that is generated through any method, such as with a previous agricultural operation, user-entered information, from the one or more field sensor 60, and/or other systems.

Additionally or alternatively, as shown in FIG. 4, the memory 106 may also include a location database 114, which may be configured to store location data generated by a location device 116 that is stored in association with the field data for later use in geo-locating the field data relative to the field 16. In some embodiments, the location device 116 may be configured as a satellite navigation positioning device (e.g. a GPS, a Galileo positioning system, a Global Navigation satellite system (GLONASS), a BeiDou Satellite Navigation and Positioning system, a dead reckoning device, and/or the like) to determine the location of the machine 10.

Moreover, as shown in FIG. 4, in several embodiments, the memory 106 may also include instructions 118 that may be executed by the processor 104 to implement a data analysis module 120. In general, the data analysis module 120 may be configured to process/analyze the captured data received from the field sensor 60, the stored data, and/or the location data. In several embodiments, the data analysis module 120 may be configured to execute one or more data processing algorithms to determine a soil compaction limit, a soil type, and/or a position of the one or more basket assemblies 44. In turn, the computing system 102 may determine a defined position of the one or more basket assemblies 44 based in part on the determined soil compaction limit and the soil type. In some cases, as the soil compaction limit within the field 16 varies, the defined position of each basket assembly 44 may be adjusted through the basket assembly actuator 46.

Referring still to FIG. 4, in some embodiments, the instructions 118 stored within the memory 106 of the computing system 102 may also be executed by the processor 104 to implement a control module 122. In general, the control module 122 may be configured to electronically control the operation of one or more components of the agricultural machine 10. For instance, in several embodiments, the control module 122 may be configured to control the operation of the agricultural machine 10 and/or the agricultural implement 14 based on the monitored soil compaction limit and/or the soil type of the field 16. Such control may include controlling the operation of one or more components of the work vehicle 12, such as the power source 30 and/or the transmission 32 of the vehicle 12 to automatically adjust the ground speed of the agricultural machine 10. In addition (or as an alternative thereto), the control module 122 may be configured to electronically control the operation of one or more components of the implement 14. For instance, the control module 122 may be configured to adjust the operating parameters (e.g., penetration depth, downforce/pressure, etc.) associated with one or more of the ground-engaging tools of the implement 14 (e.g., the disc blades 38, shanks 40, levelers 42 (e.g., leveling blades), and/or basket assemblies 44) to proactively or reactively adjust the operation of the implement 14 in view of the monitored surface condition(s).

In instances in which one or more operating parameters are adjusted, the actuation of one or more implement components may be based on data from one or more implement sensors 124. For example, the one or more implement sensors 124 can include a position sensor 126 operably coupled with the implement 14 may detect the change in position. In some examples, the position sensor 126 may be configured as an inertial measurement unit (IMU) that measures a specific force, angular rate, and/or an orientation of the implement 14 using a combination of accelerometers, gyroscopes, magnetometers, and/or any other practicable device. The accelerometer may correspond to one or more multi-axis accelerometers (e.g., one or more two-axis or three-axis accelerometers) such that the accelerometer may be configured to monitor the movement of the implement 14 in multiple directions, such as by sensing the implement acceleration along three different axes. It will be appreciated, however, that the accelerometer may generally correspond to any suitable type of accelerometer without departing from the teachings provided herein.

In several embodiments, the computing system 102 may also include a transceiver 128 to allow for the computing system 102 to communicate various components. For instance, one or more communicative links or interfaces (e.g., one or more data buses) may be provided between the transceiver 128 and a user interface 130, an electronic device 132, and/or any other device.

The user interface 130 may be housed within the cab 26 of the work vehicle 12 or at any other suitable location. The user interface 130 may be configured to provide feedback to the operator of the agricultural machine 10. Thus, the user interface 130 may include one or more feedback devices, such as display screens, speakers, warning lights, and/or the like, which are configured to communicate such feedback. In addition, some embodiments of the user interface 130 may include one or more touchscreens, keypads, touchpads, knobs, buttons, sliders, switches, mice, microphones, and/or the like, which are configured to receive user inputs from the operator.

The electronic device 132 may include a variety of computing systems 134 including a processor and memory and/or a display 136 for displaying information to a user. For instance, the electronic device 132 may display one or more user interfaces and may be capable of receiving remote user input. In addition, the electronic device 132 may provide feedback information, such as visual, audible, and tactile alerts, and/or allow the operator to alter or adjust one or more components of the agricultural machine 10 through the usage of the remote electronic device 132. For example, the electronic device 132 may be a cell phone, mobile communication device, key fob, wearable device (e.g., fitness band, watch, glasses, jewelry, wallet), apparel (e.g., a tee shirt, gloves, shoes, or other accessories), personal digital assistant, headphones and/or other devices that include capabilities for wireless communications and/or any wired communications protocols.

It will be appreciated that, although the various control functions and/or actions will generally be described herein as being executed by the computing system 102, one or more of such control functions/actions (or portions thereof) may be executed by a separate computing system or may be distributed across two or more computing systems (including, for example, the computing system 102 and a separate computing system). For instance, in some embodiments, the computing system 102 may be configured to acquire data from the field sensor 60 for subsequent processing and/or analysis by a separate computing system (e.g., a computing system associated with a remote server). In other embodiments, the computing system 102 may be configured to execute the data analysis module 120 to determine and/or monitor one or more surface conditions within the field 16, while a separate computing system (e.g., a vehicle computing system 102 associated with the agricultural machine 10) may be configured to execute the control module 122 to control the operation of the agricultural machine 10 based on data and/or instructions 118 transmitted from the computing system 102 that are associated with the monitored surface condition(s).

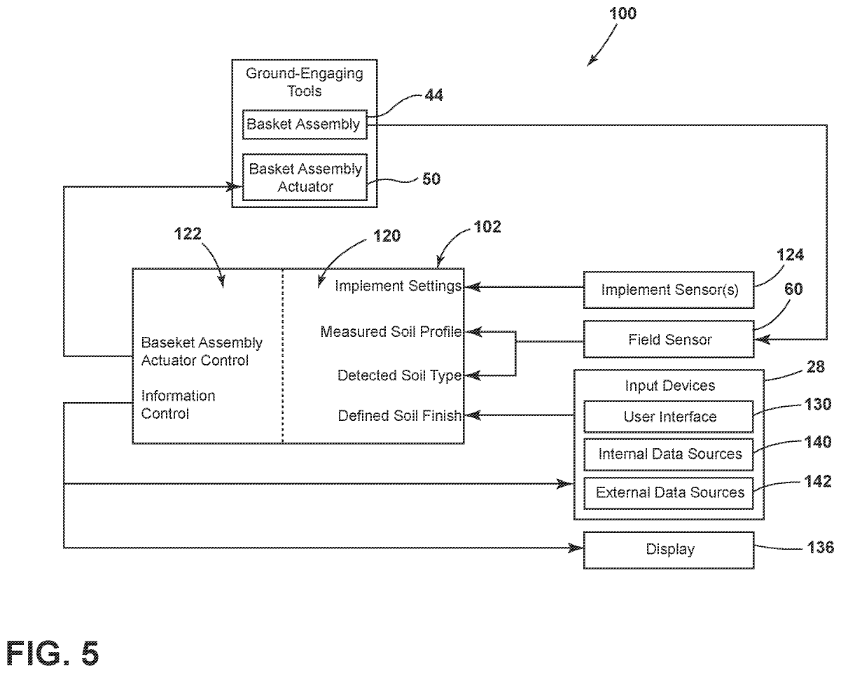

Referring to FIG. 5, various components of the system 100 are illustrated in accordance with various aspects of the present disclosure. As shown, the data analysis module 120 may receive data from various components of the system 100, such as via the field sensor 60, the implement sensors 124, and/or one or more input devices 28, and, in turn, the control module 122 can alter or manipulate various components of the implement 14, such as the basket assembly actuator 46. As provided herein, the data analysis module 120 can receive various inputs and calculate a defined position for each basket assembly actuator 46 based at least in part on a soil profile, a soil compaction limit, a soil type, and/or a current position of each basket assembly 44.

As illustrated, the data analysis module 120 may receive various implement settings from one or more implement sensors 124. In addition, the data analysis module 120 can receive a soil profile to a defined depth (e.g., six inches) from one or more field sensors 60. The data analysis module 120 may also receive data indicative of a soil type within the field 16 from the field sensor 60 and/or one or more input devices 28. Furthermore, the data analysis module 120 can receive a defined soil finish from the one or more input devices. In various cases, the one or more input devices 28 can include one or more user interfaces 130 for allowing operator inputs to be provided to the computing system 102 (e.g., buttons, knobs, dials, levers, joysticks, touch screens, and/or the like), one or more other internal data sources 140 associated with the agricultural machine 10 (e.g., other devices, stored data, databases, etc.), one or more external data sources 142 (e.g., a remote computing device or server), and/or any other suitable input devices 28. In some cases, the data analysis module 120 may receive a defined soil profile from the input devices 28.

The data analysis module 120 can process the soil data from the field sensors 60 to determine a soil compaction limit of the soil profile. Additionally or alternatively, the data analysis module 120 can process the soil data from the field sensors 60 to determine a soil type. The data analysis module 120 can then use the soil compaction limit and soil type to determine a defined basket pressure to match the defined soil finish. If a detected basket pressure to accomplish a defined soil finish is varied from the defined soil finish, the data analysis module 120 can determine an amount of movement of the one or more basket assemblies 44 to accomplish the defined soil finish through the actuation of the respective basket assembly actuators 46. In response, the control module 122 may generate instructions 118 to alter a position of the basket assembly 44 through actuation of the basket assembly actuator 46 when a detected basket assembly position varies from the defined basket assembly actuator position. Additionally or alternatively, the control module 122 may generate display instructions 118 for one or more displays 136, which may be incorporated within the user interface 130 and/or be remote from the user interface 130. For instance, the display 136 may illustrate information related to at least one of a soil profile, a soil compaction limit, a soil type, and/or a current position of each basket assembly 44.

During operation, data may be sequentially collected by the field sensor 60 and/or the implement sensors 124, which may be provided as subsequent inputs to the data analysis module 120 so that additional alterations to one or more basket assembly actuators 46 may be made, if needed. In addition, the data analysis module 120 may alter one or more subsequent outputs based on a result of a previous instruction. As such, the data analysis module 120 may learn from the results of previous instructions to alter subsequent instructions.

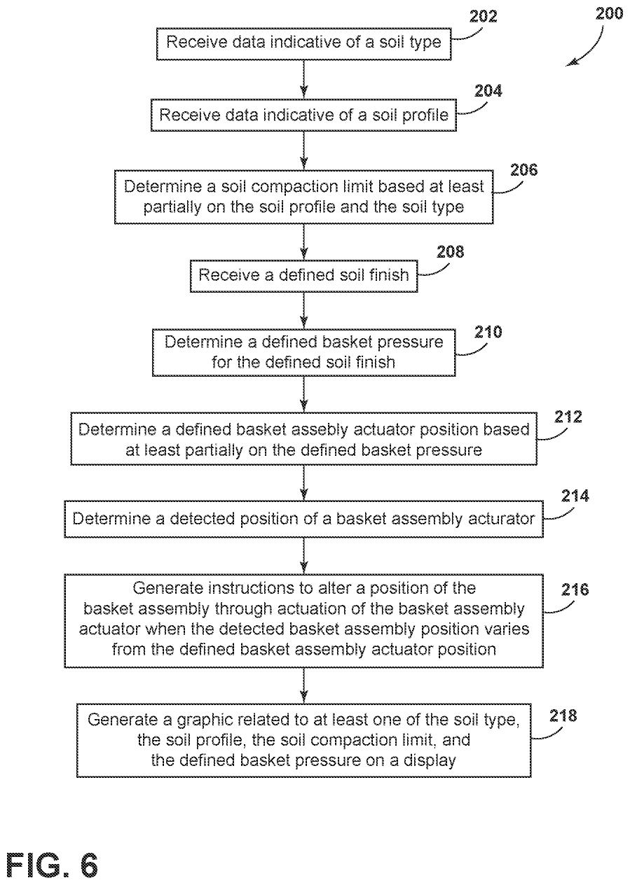

Referring now to FIG. 6, a flow diagram of a method 200 for operating an agricultural system is illustrated in accordance with aspects of the present subject matter. In general, the method 200 will be described herein with reference to the agricultural machine 10 shown in FIGS. 1-3 and the various system components shown in FIGS. 4 and 5. However, it will be appreciated that the disclosed method 200 may be implemented with agricultural machines having any other suitable machine configurations and/or within systems having any other suitable system configuration without deviating from the present disclosure. In addition, although FIG. 6 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As illustrated, at (202), the method 200 can include receiving data indicative of a soil type with a computing system. At (204), the method 200 can include receiving data indicative of a soil profile with the computing system. As provided herein, the soil profile can include a measure of soil compaction, which occurs when particles of the soil are pressed together to reduce the air space between them. As such, relatively highly compacted soils contain few spaces resulting in soil with higher unit weight and a relatively lower compacted soil can contain more spaces resulting in soil with lower unit weight. However, the soil profile data may also define any other characteristic of the soil within the field without departing from the scope of the present disclosure.

At (206), the method 200 can include determining a soil compaction limit based at least partially on the soil profile and the soil type with the computing system. As provided herein, the soil compaction limit can be determined based on various factors and may be defined by the computing system, a user of the agricultural system, and/or through any other manner.

At (208), the method can include receiving a defined soil finish. The defined soil finish may be a metric of a surface finish, which can include a measure of the soil levelness, residue coverage, and/or roughness that may be defined by clod size distribution. Surface roughness or clod sizing can be controlled by the basket pressure of the implement. As such, at (210), the method can include determining a defined basket pressure for the defined soil finish with the computing system.

At (212), the method 200 can include determining a defined basket assembly actuator position based at least partially on the defined basket pressure with the computing system. At (214), the method 200 can include determining a detected position of a basket assembly actuator with a position sensor.

At (216), the method can include generating instructions to alter a position of the basket assembly through actuation of the basket assembly actuator when the detected basket assembly position varies from the defined basket assembly actuator position with the computing system. At (218), the method can include generating a graphic related to at least one of the soil type, the soil profile, the soil compaction limit, and the defined basket pressure on a display with the computing system.

In various examples, the method 200 may implement machine learning methods and algorithms that utilize one or several machine learning techniques including. for example, decision tree learning, including, for example, random forest or conditional inference trees methods, neural networks, support vector vehicles, clustering, and Bayesian networks. These algorithms can include computer-executable code that can be retrieved by the computing system and/or through a network/cloud and may be used to evaluate and update the boom deflection model. In some instances, the machine learning engine may allow for changes to the boom deflection model to be performed without human intervention.

It is to be understood that the steps of any method disclosed herein may be performed by a computing system upon loading and executing software code or instructions that are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions that are tangibly stored on a tangible computer-readable medium. The computing system loads the software code or instructions via a direct interface with the computer-readable medium or via a wired and/or wireless network. Upon loading and executing such software code or instructions by the controller, the computing system may perform any of the functionality of the computing system described herein, including any steps of the disclosed methods.

The term “software code” or “code” used herein refers to any instructions or set of instructions that influence the operation of a computer or controller. They may exist in a computer-executable form, such as vehicle code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology. including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An agricultural system comprising:
an implement including a frame assembly;
a basket assembly operably coupled with the frame assembly;
a basket assembly actuator operably coupled with the basket assembly and the frame assembly, the basket assembly actuator configured to alter a position of the basket assembly relative to the frame assembly; and
a computing system communicatively coupled to the basket assembly actuator, the computing system including a processor and associated memory, the memory storing instructions that, when implemented by the processor, configure the computing system to:
receive a defined soil finish;
receive data indicative of a soil profile;
determine a soil compaction limit based on the soil profile; and
determine a defined basket assembly actuator position based at least partially on the soil compaction limit and the defined soil finish.

2. The agricultural system of claim 1, wherein the computing system is further configured to:
receive data indicative of a soil type.

3. The agricultural system of claim 2, wherein the defined basket assembly actuator position is further based at least partially on the soil type.

4. The agricultural system of claim 1, further comprising:
a field sensor configured to capture data indicative of one or more conditions of the field.

5. The agricultural system of claim 2, further comprising:
a user interface, wherein the soil type is provided to the computing system through the user interface.

6. The agricultural system of claim 2, further comprising:
a location device, wherein at least one of the soil profile or the soil type is based at least partially on a position of the implement within a field, as determined by the location device, and a correlated soil map.

7. The agricultural system of claim 1, further comprising:
a position sensor operably coupled with the basket assembly actuator, the position sensor configured to capture data indicative of a detected position of the basket assembly relative to the frame assembly.

8. The agricultural system of claim 7, wherein the computing system is further configured to:
generate instructions to alter a position of the basket assembly through actuation of the basket assembly actuator when a detected basket assembly position varies from the defined basket assembly actuator position.

9. The agricultural system of claim 2, further comprising:
a display operably coupled with the computing system, the computing system configured to illustrate information related to at least one of the soil profile, the soil compaction limit, the soil type, and a current position of the basket assembly.

10. The agricultural system of claim 1, further comprising:
an implement sensor configured to detect one or more implement settings associated with the implement.

11. A method for operating an agricultural system, the method comprising:
receiving, with a computing system, data indicative of a soil type;
receiving, with the computing system, data indicative of a soil profile;
determining, with the computing system, a soil compaction limit based at least partially on the soil profile and the soil type.

12. The method of claim 11, further comprising:
receiving, with the computing system, a defined soil finish; and
determining, with the computing system, a defined basket pressure for the defined soil finish.

13. The method of claim 12, further comprising:
determining, with the computing system, a defined basket assembly actuator position based at least partially on the defined basket pressure.

14. The method of claim 11, further comprising:
determining, with a position sensor, a detected position of a basket assembly actuator.

15. The method of claim 13, further comprising:
generating, with the computing system, instructions to alter a position of the basket assembly through actuation of the basket assembly actuator when a detected basket assembly position varies from the defined basket assembly actuator position.

16. The method of claim 13, further comprising:
generating, with the computing system, a graphic related to at least one of the soil type, the soil profile, the soil compaction limit, and the defined basket pressure on a display.

17. An agricultural system comprising:
an implement including a frame assembly;
a basket assembly operably coupled with the frame assembly;
a basket assembly actuator operably coupled with the basket assembly and the frame assembly, the basket assembly actuator configured to alter a position of the basket assembly relative to the frame assembly; and
a computing system communicatively coupled to the basket assembly actuator, the computing system including a processor and associated memory, the memory storing instructions that, when implemented by the processor, configure the computing system to:
receive data indicative of a soil compaction limit; and
determine a defined basket assembly actuator position based at least partially on the soil compaction limit.

18. The system of claim 17, wherein the soil compaction limit is based at least partially on a soil profile, the soil profile determined by data generated by one or more field sensors.

19. The system of claim 17, further comprising:
an implement sensor configured to generate data indicative of a detected basket assembly actuator position, and wherein the computing system is configured to generate an instruction to alter the position of the basket assembly actuator based on a variation between the defined basket assembly actuator position and the detected basket assembly actuator position.

20. The system of claim 17, wherein the soil compaction limit is at least partially based on a soil type.
